(19) United States
(12) Patent Application Publication
(10) Pub. No.: US 2026/0257887 A1
(43) Pub. Date: Sep. 3, 2026

(54) METHOD AND SYSTEM FOR PROVIDING COMMUNICATION SERVICES TO ELEVATOR PASSENGER

(71) Applicant: Otis Elevator Company, Farmington, CT (US)

(72) Inventors: Pradeep Miriyala, Hyderabad (IN); Debaranjan Das, Hyderabad (IN); Vishnu Vardhan Konakalla, Hyderabad (IN)

(21) Appl. No.: 19/404,704

(22) Filed: Dec. 1, 2025

(30) Foreign Application Priority Data
Mar. 3, 2025 (IN) 202511018707

(51) Int. Cl. B66B 1/34; B66B 3/00; B66B 5/00

(52) U.S. Cl. CPC B66B 1/3461; B66B 3/002; B66B 5/0012

(57) ABSTRACT

An elevator system, having: an elevator car; a controller operationally coupled to the elevator car; and a remote service implement, wherein the controller is configured to transmit communication data to the remote service implement utilizing a first communication channel; a local service implement, wherein the controller is configured to transmit the communication data to the local service implement utilizing a second communication channel that is the same as or differs from the first communication channel; wherein the controller is configured to: identify a trapped passenger event with the elevator car; and transmit the communication data to the local service implement utilizing the second communication channel upon determining that the controller is unable to transmit the communication data to the remote service implement utilizing the first communication channel.

### FOREIGN PRIORITY

This application claims priority to India Patent Application No. 202511018707, filed Mar. 3, 2025, and all the benefits accruing therefrom under 35 U.S.C. § 119, the contents of which in its entirety are herein incorporated by reference.

### BACKGROUND

The embodiments described herein relate to an elevator system and more specifically to a method and system for providing communication services to an elevator passenger.

During a trapped passenger event (TPE), a passenger may seek support by using video and voice solutions provided by the elevator system to communicate with a remote service implement such as a remote service center. The success of these solutions may be dependent on network traffic and may impose challenges in terms of quickly and efficiently establishing a connection between the elevator car and the service center.

### BRIEF SUMMARY

Disclosed is an elevator system, including: an elevator car; a controller operationally coupled to the elevator car; and a remote service implement, wherein the controller is configured to transmit communication data to the remote service implement utilizing a first communication channel; a local service implement, wherein the controller is configured to transmit the communication data to the local service implement utilizing a second communication channel that is the same as or differs from the first communication channel; wherein the controller is configured to: identify a trapped passenger event with the elevator car; and transmit the communication data to the local service implement utilizing the second communication channel upon determining that the controller is unable to transmit the communication data to the remote service implement utilizing the first communication channel.

In addition to one or more aspects of the system or as an alternate, the controller is configured to switch to the first communication channel upon determining that the controller is able to transmit the communication data to the remote service implement utilizing the first communication channel.

In addition to one or more aspects of the system or as an alternate, the first communication channel is established over a wide area network and the second communication channel is established over a local area network.

In addition to one or more aspects of the system or as an alternate, the remote service implement is a cloud service and the local service implement is an elevator management system located in a building in which the elevator car is located.

In addition to one or more aspects of the system or as an alternate, the elevator management system is configured to transmit the communication data to display terminal within the building or to a predetermined mobile phone.

In addition to one or more aspects of the system or as an alternate, the communication data includes voice and video data.

In addition to one or more aspects of the system or as an alternate, the system includes a communication device in the elevator car, operationally coupled to the controller configured to capture voice and video originating within the elevator car and utilizing the voice and video as the voice and video data in the communication data.

In addition to one or more aspects of the system or as an alternate, the communication device in the elevator car is one or more of: a speaker and visual display on board the elevator car; and a mobile phone of a passenger.

In addition to one or more aspects of the system or as an alternate, the controller is configured to identify the trapped passenger event with the elevator car when a passenger is detected within the elevator car and the elevator car is stopped at a landing with car doors closed for a time greater than a threshold, or the elevator car is stopped between landings for a time greater than another threshold.

In addition to one or more aspects of the system or as an alternate, the system includes a sensor operationally coupled to the elevator car, and the controller is configured to receive sensor data from the sensor, whereby the controller determines the passenger is in the elevator car.

Disclosed is a method of resolving a trapped passenger event in an elevator car of an elevator system, including: identifying, by a controller operationally coupled to the elevator car, the trapped passenger event with the elevator car; and transmitting, by the controller, communication data to a local service implement utilizing a second communication channel upon determining that the controller is unable to communicate with a remote service implement utilizing a first communication channel, wherein the second communication channel is the same as or differs from the first communication channel.

In addition to one or more aspects of the method or as an alternate, the method includes switching, by the controller, to the first communication channel upon determining that the controller is able to transmit the communication data to the remote service implement utilizing the first communication channel.

In addition to one or more aspects of the method or as an alternate, the method includes establishing, by the controller, the first communication channel over a wide area network and establishing the second communication channel over a local area network.

In addition to one or more aspects of the method or as an alternate, the remote service implement is a cloud service and the local service implement is an elevator management system located in a building in which the elevator car is located.

In addition to one or more aspects of the method or as an alternate, the method includes transmitting the communication data to a display terminal within the building or to a predetermined mobile phone.

In addition to one or more aspects of the method or as an alternate, the method provides including, in the communication data, voice and video data.

In addition to one or more aspects of the method or as an alternate, the method includes capturing, by a communication device in the elevator car that is operationally coupled to the controller, voice and video originating within the elevator car and utilizing the voice and video as the voice and video data in the communication data.

In addition to one or more aspects of the method or as an alternate, the communication device in the elevator car is one or more of: a speaker and visual display on board the elevator car; and a mobile phone of a passenger.

In addition to one or more aspects of the method or as an alternate, the method includes identifying, by the controller, the trapped passenger event when a passenger is detected within the elevator car and the elevator car is stopped at a landing with car doors closed for a time greater than a threshold, or the elevator car is stopped between landings for a time greater than another threshold.

In addition to one or more aspects of the method or as an alternate, the method includes receiving, by the controller from a sensor operationally coupled to the elevator car, sensor data, whereby the controller determines the passenger is in the elevator car.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 shows additional aspects of the system that is configured to provide communication services to an elevator passenger during a trapped passenger event, according to an embodiment; and

FIG. 3 is a flowchart showing a method of resolving a trapped passenger event in an elevator system.

### DETAILED DESCRIPTION

A detailed description of one or more embodiments of the disclosed apparatus and method are presented herein by way of exemplification and not limitation with reference to the Figures.

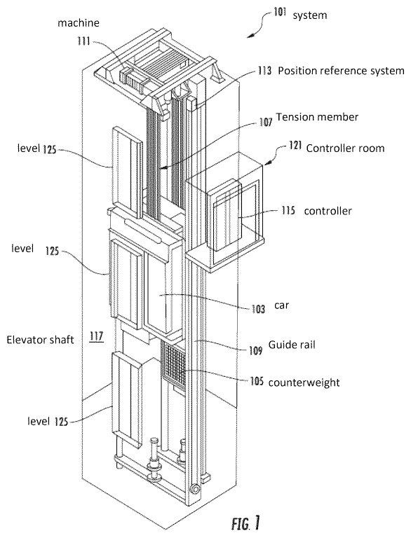

FIG. 1 is a perspective view of an elevator system 101 including an elevator car 103, a counterweight 105, a tension member 107, a guide rail (or rail system) 109, a machine (or machine system) 111, a position reference system 113, and an electronic elevator controller (controller) 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft (or hoistway) 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 may be located in a controller room 121 of the elevator shaft 117. It is to be appreciated that the controller 115 need not be in the controller room 121 but may be in the hoistway or other location in the elevator system. According to an aspect, the controller 115 is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. Embodiments may also be employed in ropeless elevator systems using self-propelled elevator cars (e.g., elevator cars equipped with friction wheels, pinch wheels or traction wheels). FIG. 1 is merely a non-limiting example presented for illustrative and explanatory purposes.

In other embodiments, the system 101 may include a conveyance system that moves passengers between landings 125 and/or along a single floor. Such conveyance systems may include escalators, people movers, etc. Accordingly, embodiments described herein are not limited to elevator systems, such as that shown in FIG. 1.

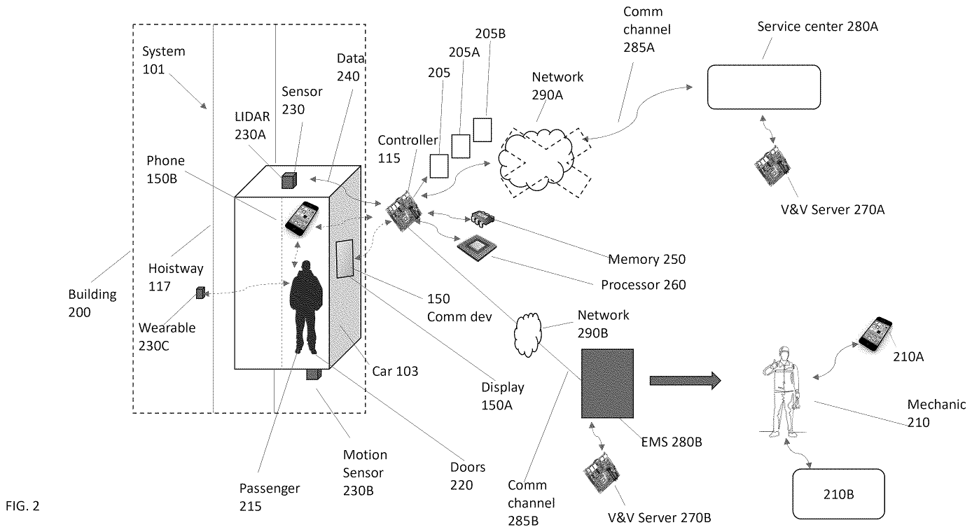

Turning to FIG. 2, the elevator system 101 includes the elevator car 103 in a hoistway 117 in a building 200 and a controller 115, which may be located on the elevator car 103 and operationally coupled to the car 103. A communication device, generally referenced as 150, may be operationally coupled to the controller 115. The communication device 150 may be a speaker and visual display, e.g., a voice and visual display 150A (or implement), onboard the elevator car 103. Alternatively, the communication device 150 may be a mobile phone 150B carried by a passenger 215. A sensor, generally referenced as 230, may be operationally coupled to the elevator car 103 and the controller 115 is configured to receive sensor data 240 from the sensor 230. From this sensor data 240, the controller 115 may determine the presence of the passenger 215 within the elevator car 103. The sensor 230 may be LIDAR 230A, a motion sensor 230B, a smart wearable 230C on the passenger 215, or some other type of sensor 230, including but not limited to a microphone, accelerometer, weight sensor, pressure sensor, etc. It is to be appreciated that the sensor 230, if a LIDAR 230A type, may be mounted within the hoistway 117 or the elevator car 103.

The controller 115, e.g., with memory 250 and a processor 260, may be able to identify a trapped passenger event (TPE) when a passenger 215 is sensed in the elevator car 103 and the elevator car 103 is stopped, with elevator car doors 220 in closed configuration for a time period that exceeds a predetermined period of time (e.g., a threshold). Alternatively a TPE may be identified when a passenger 215 is within the elevator car 103 and the elevator car 103 is stopped between landings 125 for a time period that exceeds another predetermined period of time (e.g., another threshold).

According to an embodiment, during a TPE, the controller 115 is configured to transmit communication data 205 to a remote service implement 280, i.e., a service center, which may be a cloud service, utilizing a first communication channel 285A. The first communication channel 285A may be over a wireless network 290A which may be a wide area network such as the internet, or may be cellular, satellite, WiFi, or any other type of wireless communication network. The communication data 205 may include voice and video data and the remote service implement 280 may include a (first) voice and video server 270A to process the communication data 205. The first communication channel 285A may be two-way communication channel to enable the remote service implement 280A to transmit voice and video data back to the controller 115 for display on the communication device 150 in the elevator car 103 for communicating with the passenger 215 during the TPE.

According to an embodiment, during a TPE, the controller 115 is also configured to transmit the communication data 205 to a local service implement 280B which may be an elevator management system, utilizing a second communication channel 285B that differs from the first communication channel 285A, i.e., the channels apply different protocols. In one or more embodiments, the communication channels may be the same and may apply the same protocol. For example, in one embodiment a call is initiated to both the remote server 280A and the local server 280B, and the local server call 280B is either disconnected or maintained based on a completion of a call to the remote server 280A, or vice versa.

The second communication channel 285B may be wired or wireless local area network 290B. In one embodiment the wired network may be a telephone service. The local service implement 280B may be include a (second) voice and video server 270B to process the voice and video data in the communication data 205. The second communication channel 285B may be a two-way communication channel to enable the local service implement 280B to transmit voice and video data back to the controller 115 for display on the communication device 150 in the elevator car 103 for communicating with the passenger 215 during the TPE. The local service implement 280B may communicate bidirectionally with a mobile phone 210A of a mechanic 210 or a display terminal 210B within the building 200 to enable a person, such as the mechanic 210, or any other local individual, including a building manager, doorman, local maintenance, etc., to communicate with the passenger 215.

According to an embodiment, the controller 115 is configured to prioritize the utilization of the communication channels 285A, 285B during a TPE, to reach the remote and local service implements 280A, 280B. That is the controller 115 is configured to utilize the second communication channel 285B, to reach the local service implement 280B upon determining that the controller 115 is unable to connect with the remote service implement 280A utilizing the first communication channel 285A. This could be, e.g., because of a technical issue with the first communication channel 285A. The controller 115 may be configured to switch to the first communication channel 285A when it is operable. With this configuration, there is an assurance that the passenger 215 can communicate bidirectionally with the remote or local service implements 280A, 280B during a TPE, to receive rapid assistance.

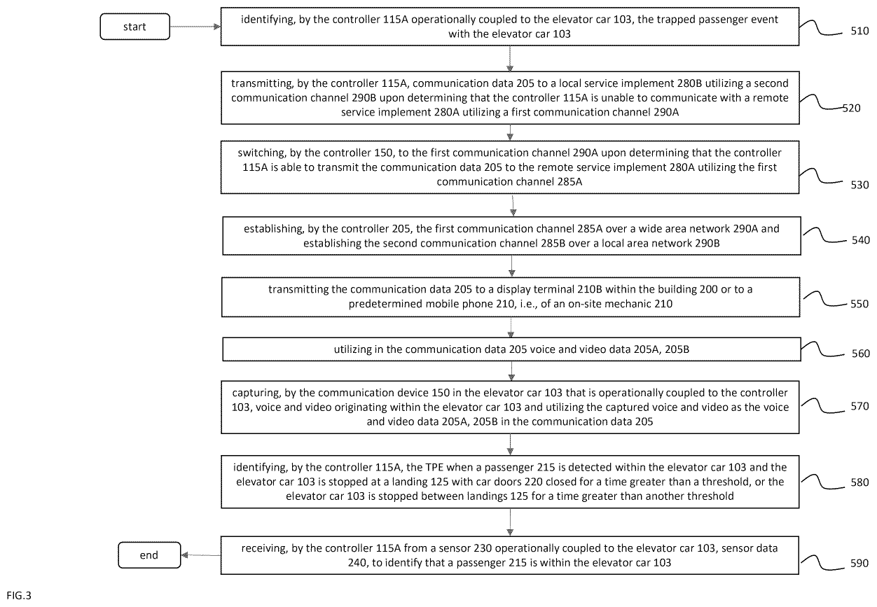

Turning to FIG. 3, a flowchart shows a method of resolving a trapped passenger event in an elevator system. As shown in block 510, the method includes identifying, by the controller 115 operationally coupled to the elevator car 103, the trapped passenger event with the elevator car 103. As shown in block 520, the method includes transmitting, by the controller 115, communication data 205 to a local service implement 280B utilizing a second communication channel 285B upon determining that the controller 115 is unable to communicate with a remote service implement 280A utilizing a first communication channel 285A. The second communication channel 285B differs from the first communication channel 285A, i.e., the channels apply different protocols. As indicated, in one or more embodiments, the communication channels may be the same and may apply the same protocol. For example, in one embodiment a call is initiated to both the remote server 280A and the local server 280B, and the local server call 280B is either disconnected or maintained based on a completion of a call to the remote server 280A, or vice versa. As shown in block 530, the method includes switching, by the controller 115, to the first communication channel 285A upon determining that the controller 115 is able to transmit the communication data 205 to the remote service implement 280A utilizing the first communication channel 285A.

As shown in block 540, the method includes establishing, by the controller 115, the first communication channel 285A over a wide area network 290A and establishing the second communication channel 285B over a local area network 290B. As indicated, the remote service implement 280A is a cloud service and the local service implement 280B is an elevator management system located in the building 200 in which the elevator car 103 is located. As shown in block 550, the method includes transmitting the communication data 205 to a display terminal 210B within the building 200 or to a predetermined mobile phone 210A, i.e., of an on-site mechanic 210.

As shown in block 560, the method includes utilizing in the communication data 205 voice and video data 205A, 205B. As shown in block 570, the method includes capturing, by the communication device 150 in the elevator car 103 that is operationally coupled to the controller 115, voice and video originating within the elevator car 103 and utilizing the captured voice and video as the voice and video data 205A, 205B in the communication data 205. As indicated, the communication device 150 in the elevator car 103 is one or more of a speaker and visual display 150A on board the elevator car 103, and a mobile phone 150B of the passenger

### 215.

As shown in block 580, the method includes identifying, by the controller 115, the TPE when a passenger 215 is detected within the elevator car 103 and the elevator car 103 is stopped at a landing 125 with car doors 220 closed for a time greater than a threshold, or the elevator car 103 is stopped between landings 125 for a time greater than another threshold. As shown in block 590, the method includes receiving, by the controller 115 from a sensor 230 operationally coupled to the elevator car 103, sensor data 240. From this, the controller 115 determines a passenger 215 is in the elevator car 103.

With the embodiments, a call directed to the remote service center that fails due to poor network connectivity or unavailability of remote service personnel will be rerouted via a local area network to a voice and video server hosted on a comping device of the elevator management system. The elevator call may be directed to computers of an administrator of a building or a mobile device or a preconfigured display terminal located on the telecommunication network for the building in which the elevator is located. With the embodiments, a peer-to-peer, or peer-to-group, communication may be established between the elevator controller and one or more devices of the building administrator. The communication may provide initial guidance to trapped passengers about the situation and keep the passengers engaged until the remote service is available. Once the remove service is available, the active communication may be switched to remote service.

In the above embodiments, sensor data may be obtained and processed separately, or simultaneously and stitched together, or a combination thereof, and may be processed in a raw or complied form. The sensor data may be processed on the sensor (e.g. via edge computing), by controllers identified or implicated herein, on a cloud service, or by a combination of one or more of these computing systems. The senor may communicate the data via wired or wireless transmission lines, applying one or more protocols as indicated below.

Wireless connections may apply protocols that include local area network (LAN, or WLAN for wireless LAN) protocols. LAN protocols include WiFi technology, based on the Section 802.11 standards from the Institute of Electrical and Electronics Engineers (IEEE). Other applicable protocols include Low Power WAN (LPWAN), which is a wireless wide area network (WAN) designed to allow long-range communications at a low bit rates, to enable end devices to operate for extended periods of time (years) using battery power. Long Range WAN (LoRaWAN) is one type of LPWAN maintained by the LoRa Alliance, and is a media access control (MAC) layer protocol for transferring management and application messages between a network server and application server, respectively. LAN and WAN protocols may be generally considered TCP/IP protocols (transmission control protocol/Internet protocol), used to govern the connection of computer systems to the Internet. Wireless connections may also apply protocols that include private area network (PAN) protocols. PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

Wireless connections may also include radio-frequency identification (RFID) technology, used for communicating with an integrated chip (IC), e.g., on an RFID smartcard. In addition, Sub-1Ghz RF equipment operates in the ISM (industrial, scientific and medical) spectrum bands below Sub 1Ghz-typically in the 769-935 MHz, 315 Mhz and the 468 Mhz frequency range. This spectrum band below 1 Ghz is particularly useful for RF IOT (internet of things) applications. The Internet of things (IoT) describes the network of physical objects—“things”—that are embedded with sensors, software, and other technologies for the purpose of connecting and exchanging data with other devices and systems over the Internet. Other LPWAN-IOT technologies include narrowband internet of things (NB-IOT) and Category M1 internet of things (Cat M1-IOT). Wireless communications for the disclosed systems may include cellular, e.g. 2G/3G/4G (etc.). Other wireless platforms based on RFID technologies include Near-Field-Communication (NFC), which is a set of communication protocols for low-speed communications, e.g., to exchange date between electronic devices over a short distance. NFC standards are defined by the ISO/IEC (defined below), the NFC Forum and the GSMA (Global System for Mobile Communications) group. The above is not intended on limiting the scope of applicable wireless technologies.

Wired connections may include connections (cables/interfaces) under RS (recommended standard)-422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a server/client protocol designed for use with its programmable logic controllers (PLCs) and which is a commonly available means of connecting industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Controller Area Network (CAN) bus. A CAN is a vehicle bus standard that allow microcontrollers and devices to communicate with each other in applications without a host computer. CAN is a message-based protocol released by the International Organization for Standards (ISO). The above is not intended on limiting the scope of applicable wired technologies.

When data is transmitted over a network between end processors as identified herein, the data may be transmitted in raw form or may be processed in whole or part at any one of the end processors or an intermediate processor, e.g., at a cloud service (e.g. where at least a portion of the transmission path is wireless) or other processor. The data may be parsed at any one of the processors, partially or completely processed or complied, and may then be stitched together or maintained as separate packets of information. Each processor or controller identified herein may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory identified herein may be but is not limited to a random access memory (RAM), read only memory (ROM), or other electronic, optical, magnetic or any other computer readable medium.

The controller may further include, in addition to a processor and non-volatile memory, one or more input and/or output (I/O) device interface(s) that are communicatively coupled via an onboard (local) interface to communicate among other devices. The onboard interface may include, for example but not limited to, an onboard system bus, including a control bus (for inter-device communications), an address bus (for physical addressing) and a data bus (for transferring data). That is, the system bus may enable the electronic communications between the processor, memory and I/O connections. The I/O connections may also include wired connections and/or wireless connections identified herein. The onboard interface may have additional elements, which are omitted for simplicity, such as controllers, buffers (caches), drivers, repeaters, and receivers to enable electronic communications. The memory may execute programs, access data, or lookup charts, or a combination of each, in furtherance of its processing, all of which may be stored in advance or received during execution of its processes by other computing devices, e.g., via a cloud service or other network connection identified herein with other processors.

Embodiments can be in the form of processor-implemented processes and devices for practicing those processes, such as processor. Embodiments can also be in the form of computer code based modules, e.g., computer program code (e.g., computer program product) containing instructions embodied in tangible media (e.g., non-transitory computer readable medium), such as floppy diskettes, CD ROMs, hard drives, on processor registers as firmware, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes a device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator system, comprising:
an elevator car;
a controller operationally coupled to the elevator car; and
a remote service implement, wherein the controller is configured to transmit communication data to the remote service implement utilizing a first communication channel;
a local service implement, wherein the controller is configured to transmit the communication data to the local service implement utilizing a second communication channel that is the same as or differs from the first communication channel;
wherein the controller is configured to:
identify a trapped passenger event with the elevator car; and
transmit the communication data to the local service implement utilizing the second communication channel upon determining that the controller is unable to transmit the communication data to the remote service implement utilizing the first communication channel.

2. The system of claim 1, wherein
the controller is configured to switch to the first communication channel upon determining that the controller is able to transmit the communication data to the remote service implement utilizing the first communication channel.

3. The system of claim 1, wherein
the first communication channel is established over a wide area network and the second communication channel is established over a local area network.

4. The system of claim 1, wherein
the remote service implement is a cloud service and the local service implement is an elevator management system located in a building in which the elevator car is located.

5. The system of claim 4, wherein
the elevator management system is configured to transmit the communication data to display terminal within the building or to a predetermined mobile phone.

6. The system of claim 1, wherein
the communication data includes voice and video data.

7. The system of claim 6, including
a communication device in the elevator car, operationally coupled to the controller configured to capture voice and video originating within the elevator car and utilizing the voice and video as the voice and video data in the communication data.

8. The system of claim 7, wherein
the communication device in the elevator car is one or more of: a speaker and visual display on board the elevator car; and a mobile phone of a passenger.

9. The system of claim 1, wherein:
the controller is configured to identify the trapped passenger event with the elevator car when a passenger is detected within the elevator car and the elevator car is stopped at a landing with car doors closed for a time greater than a threshold, or the elevator car is stopped between landings for a time greater than another threshold.

10. The system of claim 9, comprising:
a sensor operationally coupled to the elevator car, and the controller is configured to receive sensor data from the sensor, whereby the controller determines the passenger is in the elevator car.

11. A method of resolving a trapped passenger event in an elevator car of an elevator system, comprising:
identifying, by a controller operationally coupled to the elevator car, the trapped passenger event with the elevator car; and
transmitting, by the controller, communication data to a local service implement utilizing a second communication channel upon determining that the controller is unable to communicate with a remote service implement utilizing a first communication channel, wherein the second communication channel is the same as or differs from the first communication channel.

12. The method of claim 11, comprising:
switching, by the controller, to the first communication channel upon determining that the controller is able to transmit the communication data to the remote service implement utilizing the first communication channel.

13. The method of claim 11, comprising:
establishing, by the controller, the first communication channel over a wide area network and establishing the second communication channel over a local area network.

14. The method of claim 11, wherein the remote service implement is a cloud service and the local service implement is an elevator management system located in a building in which the elevator car is located.

15. The method of claim 14, comprising:
transmitting the communication data to a display terminal within the building or to a predetermined mobile phone.

16. The method of claim 11, comprising:
including, in the communication data, voice and video data.

17. The method of claim 16, comprising:
capturing, by a communication device in the elevator car that is operationally coupled to the controller, voice and video originating within the elevator car and utilizing the voice and video as the voice and video data in the communication data.

18. The method of claim 17, wherein
the communication device in the elevator car is one or more of: a speaker and visual display on board the elevator car; and a mobile phone of a passenger.

19. The method of claim 11, comprising:
identifying, by the controller, the trapped passenger event when a passenger is detected within the elevator car and the elevator car is stopped at a landing with car doors closed for a time greater than a threshold, or the elevator car is stopped between landings for a time greater than another threshold.

20. The method of claim 19, comprising:
receiving, by the controller from a sensor operationally coupled to the elevator car, sensor data, whereby the controller determines the passenger is in the elevator car.
